(19) United States
(12) Patent Application Publication
(10) Pub. No.: US 2010/0257012 A1
(43) Pub. Date: Oct. 7, 2010

(54) LEAD MANAGEMENT SYSTEM

(76) Inventors: Simon Walker, Tsawwassen (CA); Kit Lee, Richmond (CA)

Correspondence Address: SYNERGIZE INNOVATIONS INC.;ATTN: IP LEGAL DEPARTMENT, 203 - 11782 HAMMERSMITH WAY, RICHMOND, BC, V7A-5E2, CA

(21) Appl. No.: 12/302,003

(22) PCT Filed: May 22, 2007
(86) PCT No.: PCT/CA2007/000948

§ 371 Date: Nov. 21, 2008

Related U.S. Application Data
(60) Provisional application No. 60/747,917, filed on May 22, 2006.

(30) Foreign Application Priority Data
Feb. 27, 2007 (CA) 2,579,873

(51) Int. Cl. G06Q 30/00; G06Q 10/00; G06F 17/30

(52) U.S. Cl. 705/9; 705/11; 707/784; 707/E17.044; 707/780; 707/E17.014; 705/304

(57) ABSTRACT

The invention is a system for collecting, executing, tracking, and updating of customer service orders, or leads. The system remotely retrieves new leads from a third party database and assigns each new lead to a contractor based on criteria that can include the type of service and area where the service is required, and contractor resources and performance. The progress of each lead through completion of service is tracked and the third party database is updated accordingly. A contractor interface allows the contractor to access new leads and lead status. The system alerts a system manager to overdue leads. A system manager interface allows managers to track the status of the leads assigned to the contractors, the performance of the contractors and of the lead management system.

### REFERENCE TO RELATED APPLICATIONS

This application claims priority from U.S. provisional patent application No. 60/747,917 filed May 22, 2006 and Canadian patent application No. 2,579,873 filed Feb. 27, 2007. This application is a U.S. national stage entry of PCT application No. PCT/CA2007/000948 filed May 22, 2007.

### FIELD OF THE INVENTION

The present invention relates to systems for managing and tracking customer service orders. More particularly, the invention relates to the collection, execution, tracking, and updating of leads.

### BACKGROUND OF THE INVENTION

Many large retailers and wholesalers of products now also provide various product-related services. In the construction and home improvement field, large retail chains now offer installation, repair and other services related to the products sold by them.

When customers approach such retailers to obtain product-related services, it is not uncommon for the company to use contractors to follow up with the customer and to perform the services. In some cases, the contractor may in turn subcontract the service. Such an arrangement allows the retailer to provide services to a large number of customers over a large geographic area without having to maintain a large directly-employed workforce.

In the case of the larger retail chains (e.g. retailers with multiple stores in multiple locations), a call center may be set up to centrally process incoming service requests and to distribute such requests to contractors. This has the potential to render the retailer's service business more efficient by effectively contracting out the service request processing function.

However, as the customer's initial service request is to the retailer, it is important to the retailer that the customer's service request be attended to promptly. The contracting out of the service request processing function, as well as the use of service contractors and potentially subcontractors, results in a loss of control by the retailer over the timeliness of the response to the service requests and of the performance of the services.

In some cases, a call center provides a lead database for collecting incoming service requests or “leads”, and means for the contractor to review the leads to determine if they have been already taken on by a contractor or subcontractor. The contractor or subcontractor is invited to update the database to show the leads as having been taken on. Unfortunately, contractors and subcontractors are frequently not diligent in updating the database such that it becomes inaccurate. In addition, the indication that a lead has been taken up by a contractor does not provide useful information as to the actual status of the service request, or even whether the contractor has in fact contacted the customer. As a result, neither the call center that distributes the service requests nor the retailer have any means to assess the overall performance of the service request and execution system and to effectively ensure the timeliness of completion of the requested service.

U.S. Pat. No. 6,859,523 to Jilk et al. describes a network-implemented system for managing people working on information-based tasks, such as data entry and telemarketing from a call center. A task dispatcher assigns tasks to workers, for example based on the skill set of the worker and a subdivision of the task. Processes are provided to assess the quality of the final task result. The Jilk et al. system is used in an information task environment rather than in the context of contractors being assigned to initiate a call back to customers. The system does not appear to track the actual status or progress of the task, only whether the task result is submitted on time. In addition, the Jilk et al. system does not provide an interface for the workers to access the task database.

There is a need for a lead management system for contractors that interacts with a service request or lead collection system and that provides effective lead tracking and management and performance assurance and reporting.

### SUMMARY OF THE INVENTION

According to aspects of the invention, there is provided a lead management system that communicates with a lead collection database and that identifies from said database leads that are new. The leads are assigned to contractors drawn from a contractor database and are assigned based on criteria that may include the type of service and area where the service is required, and contractor resources and the contractor's performance in handling leads.

The system provides a contractor interface for updating the status of the leads for which the contractor is responsible. A lead status tracking module flags the lead and warns the contractor and/or a system manager if the status of the lead does not show the expected progress according to a predetermined timeline. There is thereby provided means for ensuring that the contractors not only update the lead database, but that they actually attend to the lead in a timely and proper manner.

The lead status is tracked in detail, including for example when a contractor is assigned, when the contractor executes a call back to a customer that requested service, when a message is left for the customer, when contact is made with the customer, when the customer cancels or the contractor rejects a job, when a quote is given, when the quote is accepted and when the service has been performed. This allows accurate performance tracking of the various contractors and prompting of the contractors to ensure that leads are progressing as required. It also allows for an assessment of specific and overall response times and hence of the responsiveness of the service request lead management system.

A system manager interface enables the system manager to keep track of the leads, their assignment and their disposition and to report lead management status to the retailer from time to time, or in real time.

An accounting module may be integrated with the system to provide allocation of proceeds related to the generation of leads and their servicing.

A calendar module may be integrated with the system, for example to allow individual contractors or sub-contractors to view appointments and tasks/obligations kept track of by the system to be displayed on daily, weekly and/or monthly calendars.

### BRIEF DESCRIPTION OF THE DRAWINGS

The invention will be more fully appreciated by reference to the detailed description and the associated drawings in which:

FIG. 1 is a diagrammatic overview of the components of an embodiment of the invention;

FIG. 2 is a flowchart of a subset of an embodiment that handles the retrieval of new leads;

FIG. 3 is a flowchart depicting a life cycle of a lead as it progresses through an embodiment of the invention;

FIG. 4 is a flowchart depicting a life cycle of a measurement lead as it progresses through an embodiment of the invention;

FIG. 5 is a flowchart depicting a life cycle of an installation lead as it progresses through an embodiment of the invention;

FIG. 6 is a flowchart depicting a lead status update life cycle; and

FIG. 7 is a network overview.

### DETAILED DESCRIPTION

The system of the present invention provides for the relaying, tracking, and updating of information regarding leads. It monitors the status of individual leads and ensures that leads are attended to in a timely manner.

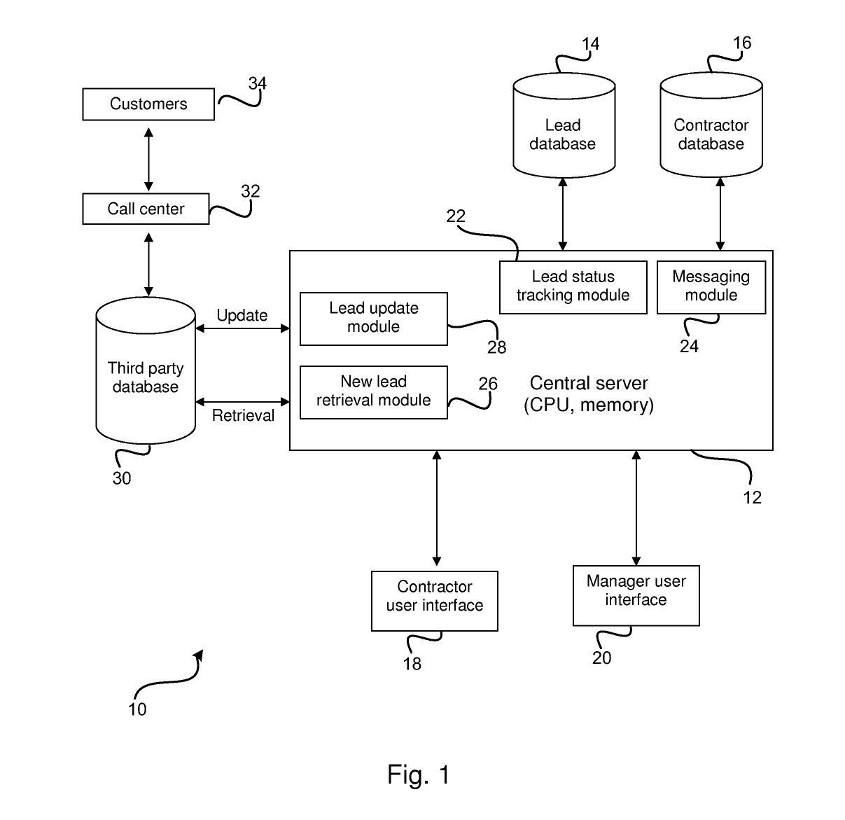

Referring to FIG. 1, a first embodiment 10 of the lead management system comprises a central server 12, a lead database 14 for storing information regarding leads, a contractor database 16 for storing information regarding contractors, a contractor user interface 18 for use by contractors to access the lead management system, and a manager user interface 20 for use by system managers to access the lead management system. The lead management system further comprises a lead status tracking module 22 to track the status of leads, a messaging module 24 to facilitate the transfer of messages from the system managers to the contractors and vice versa, a new lead retrieval module 26 to handle the retrieval and processing of new leads from an external source, and a Lead Update Module 28 to update the status of leads at the external source.

The external source for new leads may be a third party database 30 (not part of the lead management system) that may be maintained by a third party lead collector, such as a central service request call center 32. The third party lead collector receives service requests or service enquiries from potential customers 34. For example, in the construction or home improvement industry, such services may include the installation or repair of roofing, installation or repair of siding, the building of a deck, etc. It is to be understood that the service request for use with this invention can relate to any service provided by the contractor (or other service provider, whether or not a “contractor”), including services outside the realm of the construction and home improvement industries.

When a potential customer 34 first contacts the third party lead collector, basic lead information regarding each lead is collected and recorded in appropriate fields. This information is stored in the third party database 30.

The basic lead information preferably includes:
The name of and contact information for the potential customer 34;
The address (location) where the service is required;
The type of service required; and
The time and date of the inquiry.

The basic lead information may additionally include:
When the service is required;
Billing information;
The location of the store at which the potential customer shops or purchases products and services; and
The location of the store that referred the potential customer.

Preferably, the third party lead collector generates a unique lead identification code for each new lead. This lead identification code may be a numeric or alphanumeric code and is stored with the other basic lead information in the third party database 30. The records in the third party database 30 are accessible by others through a third party database interface 36 (not shown). The third party database interface 36 is preferably a web interface that can be accessed using a standard internet connection 38. Access is restricted to authorized users through the use of unique login identification names and passwords.

### New Lead Retrieval

Periodically, the lead management system, using the new lead retrieval module 26, connects to the third party database interface 36 in order to access the third party database 30. The new lead retrieval module 26 identifies leads that (1) are new and (2) relate to the type of services offered by the contractors associated with the lead management system. A new lead is a lead that has been created since the last time that the new lead retrieval module 26 accessed the third party database 30. The identified leads, with their associated information, are then retrieved from the third party database 30 and downloaded by the new lead retrieval module 26 for processing. The retrieved leads are also appropriately marked on the third party database 30 so that others accessing the third party database 30 in the future will be aware that those leads have been retrieved. Preferably, the retrieval of leads by the new lead retrieval module 26 from the third party database 30 is performed using an automated scripting process.

Once a new lead has been retrieved by the new lead retrieval module 26, a contractor is assigned to be responsible for that lead. Preferably, this assignment is performed on the basis of the following criteria:
The geographic location at which the service is required; and
The type of service required.

In one embodiment, each store operated by the retailer is associated with one or more contractors. Each contractor may be capable of performing one or more of the services offered by the store. The new lead retrieval module 26 examines the geographic location at which the service is required and determines the location of the closest store. The contractor associated with both that store and the type of service required is assigned to that lead.

In an alternative embodiment, the general area surrounding each store operated by the retailer is divided into regions, based on criteria such as postal codes. One or more contractors are associated with each region, and each contractor may be capable of performing one or more of the services offered by the store. The new lead retrieval module 26 examines the geographic location at which the service is required and determines the region containing that location. The contractor associated with both that store and the type of service required is assigned to that lead. This alternate embodiment is especially appropriate in areas of high population density or where there is a large area serviced by a single store.

Additional criteria may also be used in assigning a contractor to the lead. These include:
The contractor's backlog status for other leads as determined by the lead management system; and
The contractor's performance in dealing with past leads.

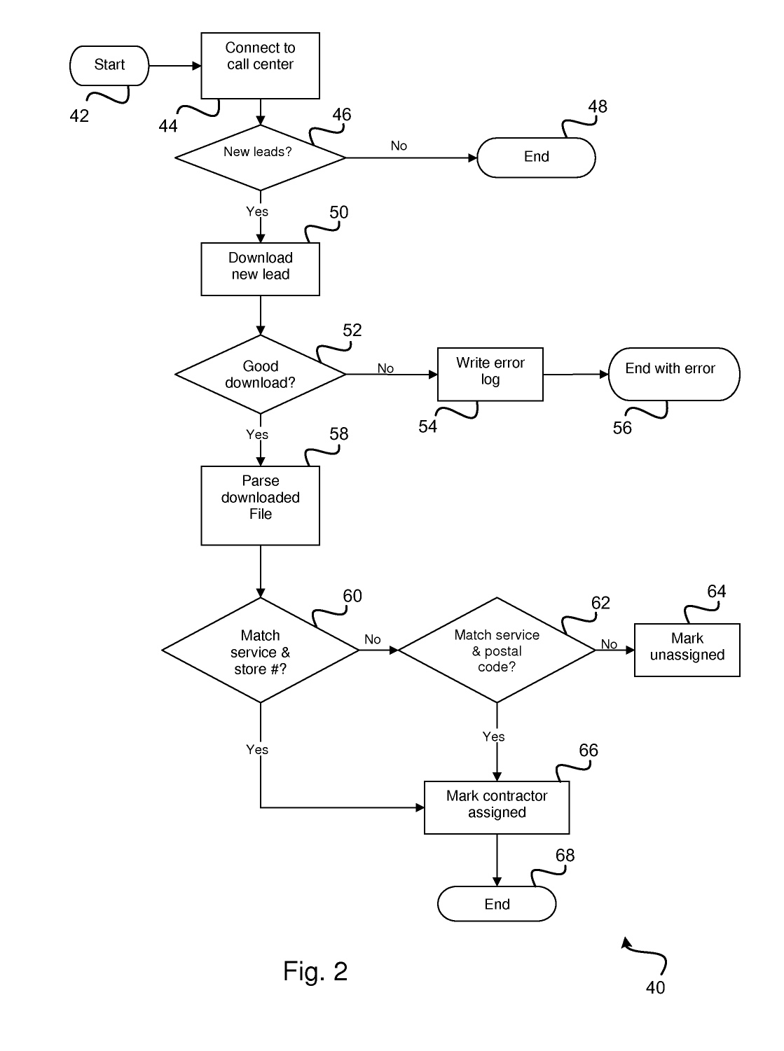

FIG. 2 is a flowchart for an embodiment of a subset of embodiment 10 that handles the retrieval of new leads by the new lead retrieval module 26. The new lead retrieval module 26 accesses the third party database 30, preferably through the third party database interface 36 via an internet connection 38, to determine whether there are any new, relevant leads that have not been previously retrieved by the new lead retrieval module 26. A relevant lead would be a lead in which the requested service can be provided by one of the contractors associated with the lead management system. If there are no such new, relevant leads, then the retrieval process is over.

If there are new, relevant leads, then the new lead retrieval module 26 downloads these leads. If a problem is detected during the download procedure, an appropriate entry is created in an error log and the retrieval process terminates with an error. If the download is successful, then the downloaded data containing the new leads is parsed and a contractor is assigned to each new lead.

If the assignment of the contractor is based on determining the closest store to the location where the service is required, then this location is examined and the location of the closest store is calculated. A contractor associated with that store and who is capable of performing the required service is assigned to that lead. The assigned contractor's identity is recorded in the information associated with that lead, and the status of the lead is also marked as CONTRACTOR_ASSIGNED (lead statuses discussed later). The lead information is stored in the lead database 14, and the contractor database 16 is updated to reflect that the contractor has been assigned the new lead.

If the assignment of the contractor is based on the absolute location of where the service is required (e.g. by postal code), then this location is examined and a contractor associated with that store and who is capable of performing the required service is assigned to that lead. The assigned contractor's identity is recorded in the information associated with that lead, and the status of the lead is also marked as CONTRACTOR_ASSIGNED. The lead information is stored in the lead database 14, and the contractor database 16 is updated to reflect that the contractor has been assigned the new lead.

If for some reason it is not possible to assign a contractor to a new lead, then the status of the lead is marked as UNASSIGNED. This may occur if the store closest to the location where service is required is not able to provide a contractor for a particular type of service that should normally be available.

After all the new leads have been dealt with, the retrieval process is completed.

FIG. 2 illustrates an embodiment of the above as process 40 in which a process starts 42 by connecting to the call center 44 and checks to see if there are any new leads 46. If no new leads are identified, then the process ends 48. If new leads are identified then the process proceeds to step 50 where the new lead is downloaded. The download is then checked 52 to see if it was a good download. If there was a problem, then an error log is written 54 and the process ends with an error 56. If the download is good, then the download is parsed 58. The service and the store most closely related to the customer is attempted to be matched 60. The store most closely related to the customer may be the store that is geographically closest or it may be the store where the customer prefers to shop. If there is a match 62, then a suitable contractor is assigned 66 and the process ends 68. If there is no match 62, the method attempts to locate a match for the service and postal code. If a match is found, then the contractor is assigned in step 66. If no match is found then the mark is unassigned 64.

### Lead Statuses

For each lead, a lead status data field is associated with the basic lead information to allow the system to track the progress of the lead. Preferably, this lead status data field will have one of the following values (corresponding to the status of the lead):
1. CONTRACTOR_ASSIGNED (after a contractor is assigned to the lead);
2. CUSTOMER_CONTACTED (after the contractor has made contact with the potential customer);
3. CUSTOMER_CANCEL (after the potential customer has cancelled the service);
4. CONTRACTOR_REJECTED (after the contractor has rejected the job);
5. PENDING (after the lead is put on hold);
6. QUOTE_GIVEN (after the contractor has provided a quote to the potential customer);
7. JOB_SOLD (after the customer has agreed to purchase the service);
8. INSTALLATION_COMPLETE (after the contractor has completed the service);
9. UNASSIGNED (for leads that are not assigned to any specific contractor); and
10. OVERDUE (a general lead status value indicating that the timeframe set for a specific action for the lead has lapsed).

Additional lead status values may also be used if a greater degree of specificity is desired.

Additional data fields may record information associated with lead status changes, such as the time and date of the status change. Also, information specific to each lead status may also be recorded.

### Lead Life Cycle

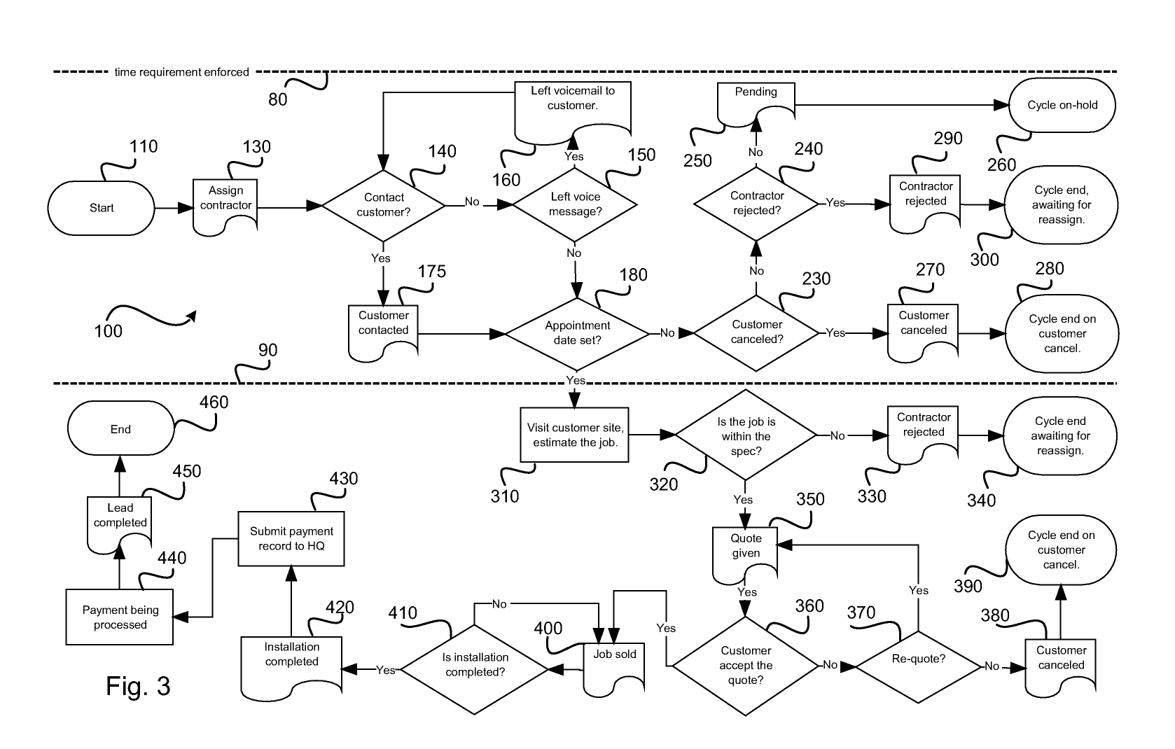

FIG. 3 is a flowchart depicting the typical life cycle of a lead as it progresses through part of the lead management system.

Once a contractor has been assigned to a lead (i.e. its lead status is CONTRACTOR_ASSIGNED), the contractor is notified of the new lead through one or more of several communication means. These include appearing in a list of new leads displayed by the contractor user interface 18 when the contractor logs on to the lead management system or appearing in a electronic mail message sent by the lead management system.

Once the contractor has attempted contact with the potential customer 34, the contractor, through the contractor user interface 18, modifies the status of the lead to CUSTOMER_CONTACTED. In addition, the contractor is able to add additional information specific to the current lead status. For example, if the contractor was unsuccessful in contacting the potential customer 34 but instead left a message, then the contractor records this information and sets a date for follow-up action, if necessary. If the contractor was able to contact the customer and has arranged for an appointment to visit the location where service is required, the date and information regarding the appointment is recorded.

If the customer decides to cancel the order (e.g. if the customer decides not to have the service done at this time), then the contractor, through the contractor user interface 18, modifies the status of the lead from CUSTOMER_CONTACTED to CUSTOMER_CANCEL. In addition, the contractor records information as to why the customer cancelled the order. Once the status of a lead is CUSTOMER_CANCEL, the life cycle for that lead is over.

If the contractor decides to reject the order, then the contractor, through the contractor user interface 18, modifies the status of the lead from CUSTOMER_CONTACTED to CONTRACTOR_REJECTED. This may occur if the contractor determines that the service required by the potential customer 34 is outside of the contractor's expertise (before or after a scheduled appointment) or if the contractor has insufficient resources to perform the service at this time. The contractor records information as to why the contractor rejected the order. Once the status of a lead is CONTRACTOR_REJECTED, the lead is flagged for reassignment later to another contractor (i.e. the lead status will eventually become UNASSIGNED).

If the contractor has contacted the potential customer 34 but the potential customer 34 has not yet decided whether to proceed with the order, the contractor, through the contractor user interface 18, modifies the status of the lead from CUSTOMER_CONTACTED to PENDING. The contractor records information such as a date when the contractor should follow-up with the potential customer 34. At this point, the life cycle for the lead is put on hold. Subsequently, the contractor is able to modify the status of the lead from PENDING to CUSTOMER_CANCEL, CONTRACTOR_REJECTED, or QUOTE_GIVEN, depending on how the potential customer 34 wishes to proceed.

If the contractor decides to proceed with the order (i.e. after the scheduled appointment), the contractor may provide the potential customer 34 with a quote to cover the service required. The contractor, through the contractor user interface 18, modifies the status of the lead from CUSTOMER_CONTACTED to QUOTE_GIVEN. Information regarding the quote, including the date to which the quote is effective, is recorded by the contractor.

If the potential customer 34 rejects the quote, the contractor has the opportunity to provide further quotes. If the contractor is ultimately unsuccessful in producing a quote that the potential customer 34 can agree to, then the contractor, through the contractor user interface 18, changes the status of the lead from QUOTE_GIVEN to CUSTOMER_CANCEL. The reason for the potential customer 34 canceling the order is recorded, and the life cycle for that lead is completed.

If the customer 34 accepts the original quote (or a subsequent quote), then the contractor, through the contractor user interface 18, changes the status of the lead from QUOTE_GIVEN to JOB_SOLD. The contractor also records information regarding the contracted job, including the agreed-to price, the estimated start date, and the estimated completion date. The lead management system ensures that the entered estimated start date and the estimated completion date are not too far in the future.

After the required service has been rendered, the contractor, through the contractor user interface 18, changes the status of the lead from JOB_SOLD to INSTALLATION_COMPLETE. The contractor also records information regarding the completed job, including the final, actual price, actual completion date, and payment information. Once the customer 34 has made payment, the life cycle of the lead is completed.

Throughout the life cycle of each lead, specific time limits are imposed by the lead management system for each status. These time limits are designed to ensure that leads are attended to in a timely manner. For example, in embodiment 10, there is a time limit of 48 hours after a contractor has been assigned a new lead within which the contractor must contact the potential customer 34. Similar time limits are applied to other stages of the life cycle of a lead. These time limits may be adjusted by the system managers. A lead status tracking module monitors and assesses whether a time limit for a lead has exceeded and if so, the lead status tracking module changes the status of the lead to OVERDUE. Information regarding the reason why the lead is overdue may also be recorded.

Periodically, the lead update module 28 will access the third party database 30 through the third party database interface 36. The lead update module 28 will update the status of those leads in the third party database 30 that are being handled by the lead management system to reflect the current status of the leads. It may be the case that the denomination of lead status values used by the lead management system will not correspond to that used by the third party database 30 and therefore, appropriate adjustments have to be made by the lead update module 28 to ensure compatibility between the lead management system and the third party database 30.

FIG. 3 illustrates an embodiment of the above as process 100 demonstrating an overview of how a lead can be handled from assigning a contractor through to completing the lead. The process starts 110 by assigning a contractor 130. Then the customer is attempted to be contacted 140 by the contractor. If the customer is contacted 175 then an appointment date 180 is attempted to be set up. If no appointment is set up then this would be because the customer cancelled 230, 270 the lead in which case the process ends 280 or the contractor has rejected the lead 240, 290 in which case the process ends 300. In a third possibility, if the customer did not cancel and the contractor did not reject the lead, then the lead remains pending 250 and is put on hold 260. A lead on hold 260 could resume the process at step 175 or it could be assigned to a new contractor at step 130. If the contractor is unable to contact the customer at step 140, then the contractor should attempt to leave a voicemail message 150, 160. If the voicemail is left, then the customer can be contacted to set up an appointment at a later time or date. If the customer is contacted and an appointment set, then the contractor will visit the customer's site on the specified date 310. The process steps shown in FIG. 3 between lines 80 and 90 may have a time dependency enforced by the retailer, such as a requirement that the contractor contact the customer and arrange an appointment within 48 hours of the time the customer first contacted the call center. This time deadline can be tracked by the system.

Upon site visit the contractor can determine 320 whether the job is within the specifications that will allow the contractor to proceed. If it is not within specification, then the contractor can reject the lead 330 and the cycle can end, possibly waiting for reassignment 340 to a suitable alternative contractor. If the job is within specification, then a quote is given 350. If the customer does not accept the quote 360 then the contractor may either requote 370 or the job may be cancelled 380 bringing an end to the process 390. If the customer accepts the quote 360 then the job is considered sold 400. Is the installation completed 410? If so, then the job is completed 420 and payment record is submitted to the headquarters 430, the payment is processed 440 and the lead is completed 450 ending the process 460. The lead management system can keep track of the status of each of these steps.

### Lead and Contractor Databases

The information associated with each lead is stored in the lead database 14 maintained by the lead management system.

The contractor database 16 is also maintained by the lead management system. The contractor database 16 stores information relating to each contractor. This information may include the contractor's contact information, the type of services offered by the contractor, the number of personnel or amount of equipment operated by the contractor, and past job history of the contractor. Additional information may include preferences specified by the contractor, such as preferred areas for customers 34, or other manager-defined criteria.

In embodiment 10, the total amount of sales generated by the contractor for a given period of time is stored in the contractor database 16, along with a predetermined target goal for the amount of sales for the contractor during that period. This allows the contractor to track its sales performance.

### Contractor User Interface

Referring back to FIG. 1, the central server 12 preferably is running web server software, such that the contractor user interface 18 and the manager user interface 20 can both access the central server 12 using a personal computer through an internet connection 38. A web server provides client authentication and application launch services.

Preferably, the contractor user interface 18 for each contractor is unique and displays information relevant only to that contractor. Each contractor accesses the contractor user interface 18 through the entry of a unique username and password. The contractor user interface 18 is preferably a graphical user interface (gui), such as a browser display screen or window, and allows the contractor to access other screens and reports, which are used to display various information to the contractor.

In embodiment 10, when the contractor logs onto the contractor user interface 18 specific to that contractor, the first screen typically displays one or more lists of leads that the contractor may attend to. These lists include the following:
a list of new leads that have been recently assigned to that contractor and that the contractor has not yet contacted;
a list of overdue new leads (i.e. leads that have been assigned to the contractor and that the contractor has not contacted within the preset time limit);
a list of leads that are at or past the CUSTOMER_CONTACTED status and that have a preset time limit for action by the contractor expiring on that day;
a list of otherwise generally overdue leads (i.e. leads that are at or past the CUSTOMER_CONTACTED status and that are past a preset time limit for action by the contractor); and
a list of leads with the QUOTE_GIVEN status.

Leads that are new overdue leads or generally overdue leads should be attended to by the contractor as soon as possible. Leads with the QUOTE_GIVEN status are also known as “warm” leads and represents potential customers 34 to whom a quote has already been given. These leads may be followed up by the contractor if time permits. These “warm” leads may be stored in a separate database (not shown) or stored in the lead database 14 but flagged as being “warm” leads.

Preferably, a menu is available for the contractor to navigate through the various screens and reports generated by the contractor user interface 18.

In embodiment 10, the contractor user interface 18 also displays the amount of sales achieved by the contractor for a specific period of time, to view the contractor's sales target for that specific period, and to track the contractor's progress in achieving the sales target for that specific period. These sales numbers are updated by the lead management system in real time. The sales achieved and sales target information may be displayed graphically, such as using a sales thermometer or other graph showing how the sales achieved compares to the sales target. The sales figures for the contractor are updated each time the contractor modifies the status of a lead to JOB_SOLD and when final payment is made. If the contractor is responsible for service requests for more than one store, the contractor user interface 18 allows the contractor to view the sales target figures for each store.

Through the contractor user interface 18, the contractor is able to retrieve and view the status of any lead assigned to the contractor and to retrieve and view information associated with that lead. For example, the contractor can view information such as the following:
lead identification code;
date of lead creation;
name and contact information of the potential customer 34;
a map of the immediate vicinity of the potential customer 34;
type of service required;
any other details about the service or the potential customer 34;
location of the nearest store (if applicable); and
location of the store where the potential customer 34 shops (if applicable).

Preferably, the contractor will not be able to view information regarding leads assigned to other contractors.

In addition to retrieving and viewing the status of leads, the contractor is also able to update the status of leads assigned to the contractor through the contractor user interface 18. The contractor updates the status of a lead when the appropriate action has taken place (e.g. the contractor can update the status from CUSTOMER_CONTACTED to QUOTE_GIVEN after the contractor has provided a quote to the potential customer 34). The contractor is also able to enter information appropriate to the status of the lead (e.g. if the status is CUSTOMER_CONTACTED, then the contractor can enter in the date of a scheduled appointment with the potential customer 34, if applicable).

Preferably, the contractor user interface 18 will ensure that for some lead statuses, certain mandatory information is entered by the contractor. For example, when the status of a lead changes from QUOTE_GIVEN to JOB_SOLD, the contractor user interface 18 will ensure that the agreed-to price must be entered by the contractor before the status change can be recorded. Similarly, if the status of a lead is changed by the contractor to CUSTOMER_CANCEL, the contractor user interface 18 will ensure that an explanation for the potential customer 34 canceling the order is entered by the contractor. The types of information that are mandatory for the contractor to enter can be predetermined by the system managers.

Furthermore, the contractor user interface 18 also ensures that only certain status changes are allowed, so that the contractor must progress through the life cycle of each lead in a systematic manner. For example, the contractor user interface 18 will not allow the contractor to change the status of a lead from CONTRACTOR_ASSIGNED to JOB_SOLD without first progressing through the intervening statuses (as well as entering the mandatory information associated with each of those statuses).

The contractor user interface 18 also allows the contractor to view the history of any lead assigned to the contractor. These leads are retrieved from the lead database 14 using a search facility provided by the contractor user interface 18. The contractor user interface 18 will allow the contractor to view the previous lead statuses for that lead and the associated information for those lead statuses. Preferably, if the lead was reassigned to the contractor from another contractor, any information regarding the lead and its statuses from before the reassignment will not be visible to the current contractor responsible for the lead.

In embodiment 10, the contractor user interface 18 will also allow the contractor to access other screens to obtain management, reporting, and other general information. For example, the contractor user interface 18 allows the contractor to manage subcontractors working for the contractor. The contractor may assign specific leads to individual subcontractors for attention and may create or delete profiles for subcontractors. In an alternative embodiment, the lead management system may automatically assign leads to individual subcontractors based on pre-established criteria set by the contractor.

The contractor user interface 18 also allows the contractor to access and view reports generated from data in the lead database 14 and contractor database 16. The contractor accesses and views reports based on various parameters, including lead status and type of service required. These reports may also be broken down according to sale prices or subcontractors.

The contractor user interface 18 also allows the contractor to view messages sent to the contractor from the system managers through the messaging module 24. Preferably, there are two types of messages: normal messages and system messages. Normal messages are accessed and viewed by navigating to the appropriate screen using a menu. System messages are higher-priority, extraordinary messages that will display on the screen when the contractor first logs onto the lead management system. Preferably, the contractor user interface 18 ensures that the contractor has read system messages before accessing the other parts of the contractor user interface 18. The contractor user interface 18 also allows the contractor to send messages to the system managers. These messages are inputted through the contractor user interface 18 and the messages will then be delivered by the messaging module 24 for display on the manager user interface 20.

The contractor user interface 18 also allows the contractor to view and download general information, such as documentation relating to the lead management system, promotions offered by the store, or useful links. These links include internet links to suppliers of raw materials.

In an alternative embodiment, the lead management system also tracks the purchases by the contractor of raw materials to be used in performing services for assigned leads. The contractor user interface 18 provides a screen for the contractor to input in the amount and cost of raw materials purchased by the contractor for a particular. This information is then stored in the lead database 14.

### Manager User Interface

The system managers are able to access the lead management system through the manager user interface 20. The system managers access the manager user interface 20 through the entry of an username and password. The manager user interface 20 is preferably a graphical user interface and allows the system managers to access other screens and reports, which are used to display various pieces of information to the system managers. The system managers can navigate through the various screens and reports of the manager user interface 20 using a menu.

The manager user interface 20 allows the system managers to view all leads and all contractors associated with the lead management system.

Preferably, when the system managers log onto the manager user interface 20, a screen displaying a list of unmatched leads (i.e. leads with the status of UNASSIGNED) and a list of overdue leads (i.e. leads with the status of OVERDUE) will appear. These leads should be dealt with as soon as possible by the system managers. For unmatched leads, the system managers use the manager user interface 20 to manually assign a contractor to an unmatched lead, at which point the status of the lead is modified to CONTRACTOR_ASSIGNED and the lead progresses through its normal life cycle. For overdue leads, the system managers may access and view the history for that lead. The system managers may then send a message through the manager user interface 20 (and using the messaging module 24) to the contractor responsible for the overdue lead.

The manager user interface 20 allows the system managers to access and view any lead present in the lead database 14. The manager user interface 20 provides a search facility to allow the system manager to search for a particular lead based on various parameters, such as lead identification code or customer 34 name.

Once the system managers have accessed a particular lead, the manager user interface 20 allows the system managers to modify any information, including lead status, associated with that lead. The system managers can unassign a lead (i.e. change its status to UNASSIGNED) or they can assign a lead from one contractor to another contractor. Unlike contractors, the system managers can also arbitrarily change the status of lead without regard to the normal progression of lead statuses through the lead's life cycle. For example, system managers can modify the status of a lead from CUSTOMER_CONTACTED to JOB_SOLD, if desired. System managers may also create and delete leads as necessary.

In addition to viewing and managing leads, the manager user interface 20 preferably also allows the system managers to view and manage contractors. The manager user interface 20 allows the system managers to register new contractors with the lead management system, by inputting in the appropriate data for the new contractor.

The manager user interface 20 also allows the system managers to send messages (either normal or system) to all contractors or to specific contractors. The system managers can input the message using the manager user interface 20 and specify the recipient(s) and the message's priority. The messaging module 24 takes the message and delivers it to the appropriate recipient(s) with the desired priority. The recipient(s) (i.e. contractors) will be able to view the message through the contractor user interface 18.

The manager user interface 20 further allows the system managers to set and adjust the time limits or thresholds for various steps in the life cycle of a lead (e.g. the time limit for contacting customers).

The manager user interface 20 allows the system managers to generate and view reports based on information in the lead database 14 and the contractor database 16. For example, these reports could include reports on sales generated by particular contractors or reports on the timeliness of particular contractors.

It is possible that some of the system managers accessing the lead management system through the manager user interface 20 will be customer support personnel who receive calls or enquiries from potential customers 34 regarding particular leads or contractors. The manager user interface 20 may comprise a facility for such system managers to enter in information or comments from such customer calls or enquiries for the appropriate lead. The system manager is able to selectively suppress such information or comments so that they are not visible by the contractor when viewing the lead.

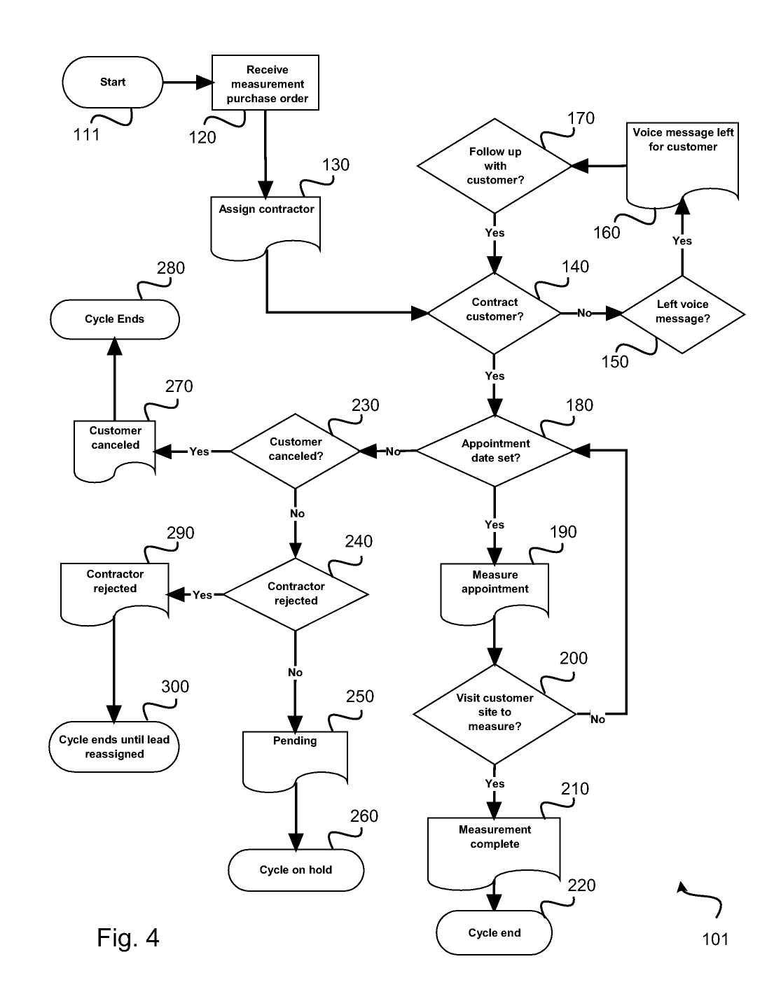

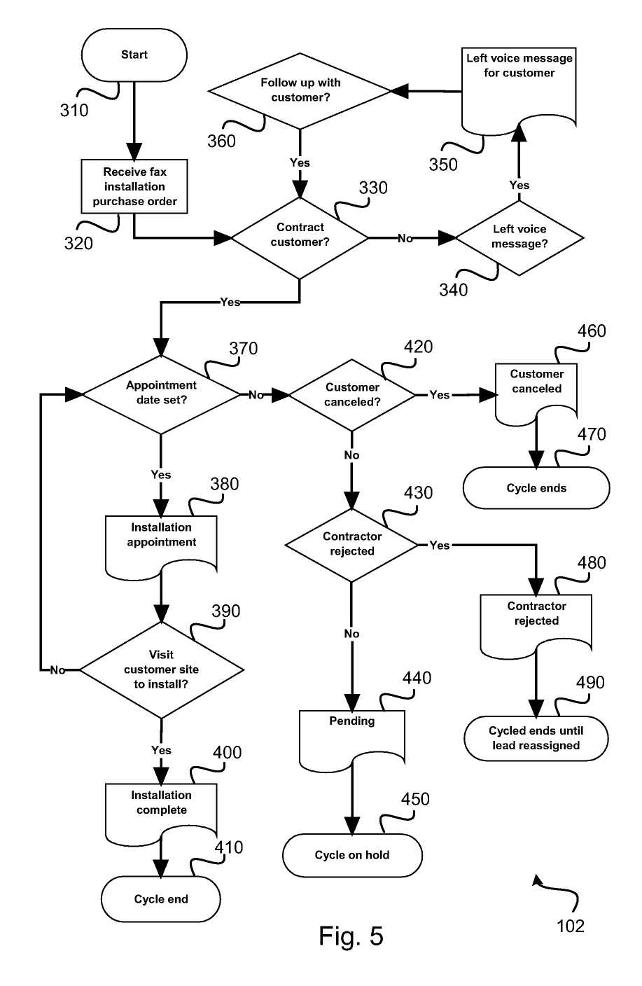

FIGS. 4 and 5 show processes 101 and 102 to illustrate methods of processing measurement purchase orders (120) and installation purchase orders (320) respectively.

Process 101 starts 111 with receiving a measurement purchase order 120. A contractor is assigned 130 who attempts to contact the customer 140. If the customer is not contacted, the contractor attempts to leave a voicemail 150, 160 and later follows up with the customer 170. If the customer is contacted 140 then the contractor tries to set up an appointment date 180. If the appointment is set 190 then the contractor attempts to visit the customer 200 to measure. If successful, the measurement is done 210 and the cycle ends 220. If an appointment date is not set, it may not have been set because the customer cancelled 230, 270 in which case the cycle ends 280. If it was not set but the customer did not cancel 230 then the contractor may have rejected the lead 240. If so 290, then the cycle ends 300 until the lead is reassigned. If the contractor did not reject the lead, then the lead remains pending 250 and the cycle is placed on hold 260.

Process 102 starts 310 with receiving a fax installation purchase order 320. The contractor attempts to contact the customer 330 and if unsuccessful attempts to leave a voice message 340, 350 to later follow up with the customer 360. If the customer is contacted, then the contractor attempts to set up an appointment date 370 to proceed with the installation appointment 380, visit the customer for installation 390, to complete the installation 400 and end the cycle 410. If an appointment is not set 370, then the customer may have cancelled 420, 460, in which case the cycle ends 470. It is also possible that the contractor rejected the lead 430, 480 in which case the cycle ends 490 until the lead is reassigned. If customer did not cancel and the contractor did not reject the lead, then the lead remains pending 440 and the cycle is on hold 450, likely awaiting further information or a decision from the customer.

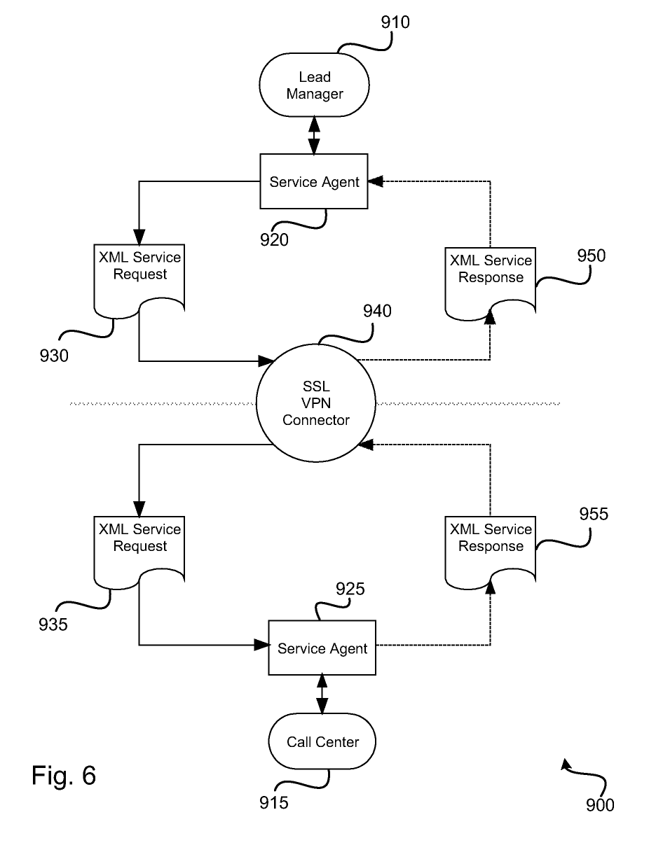

FIG. 6 illustrates a life cycle process 900 for updating the lead status between the lead management system 910 and the call center 915. The lead management system 910 uses a service agent 920 to submit an XML service request 930 via an SSL VPN connector 940 which is then transmitted as an XML service request 935 to a service agent 925 which in turn corresponds with the call center 915. The call center 915 uses a service agent 925 to submit an XML service response 955 via an SSL VPN connector 940 which is then transmitted as an XML service response 950 to a service agent 920 which in turn corresponds with the lead management system 910. This is the process used by the lead management system 910 to locate new leads and/or update the call center 915 regarding the status of leads.

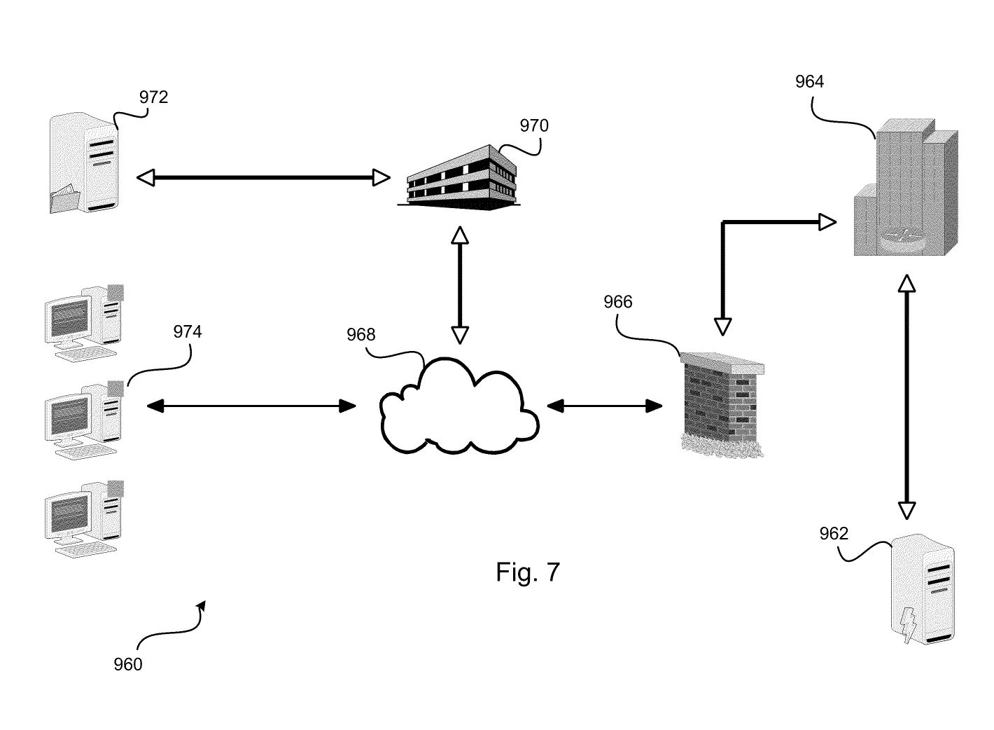

FIG. 7 shows a network overview 960 for the lead management system. The lead management server group 962 corresponds with a local data center 964 inside a firewall 966. The connections between these three parts may be any suitable connection such as a 1 Gbps Ethernet; TCP/IP connection at current standards. The firewall in turn communicates via an Internet connection 968 with the call center 970 and with client computers 974. The retailer's computer system 972 may communicate directly with the call center 970 or over the Internet. The Internet connection between the firewall 966 and the client computers 974 may be any suitable connection, such as a 2.5 Mbps xDSL (over phone-fiber) TCP/IP connection. Client computers 974 may include contractor computers or may include management computers.

### Alternative Embodiments

In addition to the functionality described above, the lead management system may comprise additional features and functions that may not be illustrated in the accompanying figures.

For example, the lead management system sends a daily report electronically (e.g. through electronic mail) to the system managers listing all overdue leads, unassigned leads, or leads due on that day (i.e. leads that must be acted upon by that date). This will allow the system managers to see which leads require immediate action. This daily report is sent remotely to mobile communications devices carried by system managers.

The lead management system also comprises an accounting subsystem that allows the contractors and the system managers to track payment status and history. The accounting subsystem tracks when payments are made, the amount of the payments, and overdue status. The appropriate amounts to be retained by the various parties (e.g. the contractor, the system managers, and the store) can be calculated and automatically processed, thereby integrating the lead management functions with the accounting function that depend on lead management. The contractor is able to scan in, through the contractor user interface 18, documents relating to payment. These documents are stored in the lead management system in a separate database (not shown) or in the lead database 14. This enables the contractors and the system managers to view the financial status associated with the contractors' leads and to effect faster payment for the various parties.

In another embodiment, the retailer can access the lead management system to generate reports regarding leads based on their status. These reports are generated based on information from the lead database 14. Additional reports based on the overall lead response timeliness of the contractors can also be generated. Preferably, the retailer can download these reports or the system can forward these reports to the specific stores that generated the leads. The retailer can also generate reports detailing the total amounts of different types of raw materials used or purchased by one or more contractors for their leads. These reports are used in calculating rebates from raw material suppliers to the retailer.

In an alternate embodiment, the contractor accesses the contractor user interface 18 using a mobile communications device, such as a smartphone device. Preferably, the mobile communications device also comprise facilities for obtaining digital photographs (i.e. a digital camera) such that the contractor can carry the device and take photographs of locations where the service is required. These photographs are uploaded using the contractor user interface 18 to the lead database 14. In addition, the device also comprises facilities for locating the position of the device (i.e. through a global positioning system, or GPS, receiver). This would allow the lead management system to track the locations of the contractors and allow the system managers to identify which contractors are closest to particular potential customers 34. The lead management system can immediately assign a new lead to the contractor closest to the potential customer identified in the new lead. The contractor can then attend to the potential customer 34 quickly or allow the new lead to be processed in the usual manner.

Such mobile communications devices would allow the contractor to connect to the central server 12 from the device through an internet connection 38 established over the cellular phone network or another wireless connection (e.g. WiFi). The contractor would access the contractor user interface 18 programmed into the device, preferably programmed into a removable external memory card (e.g. a miniSD card) inserted into the device. Aspects of the contractor user interface 18 such as the layout of various screens would be programmed into the device, and only raw data relating to the leads would be transferred between the device and the central server 12. As only raw data would need to be transferred, this would reduce the amount of bandwidth needed for the contractor to properly operate the contractor user interface 18. The programming necessary to implement the contractor user interface 18 on the mobile communications device is stored on and executed from the removable external memory and connects wirelessly to the remote central server 12. The contractor enters information through the contractor user interface 18 using touchscreen technology (e.g. a stylus) or a keyboard attached to the mobile communications device.

Preferably, any data transferred from the central server 12 to the contractor user interface 18 on the device is not retained by the device after the contractor logs out. This ensures that if the device is misplaced, there would be no data compromised.

A further embodiment comprises a dispute resolution module that handles and tracks the progress of disputes between a contractor and a potential customer 34. When a potential customer 34 makes a complaint (e.g. by calling a system manager through a customer 34 support centre), a dispute resolution mechanism is triggered. This dispute resolution mechanism allows the customer 34 and the contractor to enter information regarding the dispute. The contractor enters information through the contractor user interface 18 while the customer 34 relays the information to the system managers who then enter information through the manager user interface 20. If the dispute involves a service or installation performed by the contractor, an inspection may be conducted by a representative of the retailer, who also enters information through the manager user interface 20. The dispute resolution module tracks and coordinates the different information from the different parties. It also prompts the respective parties to perform subsequent steps in the dispute management process and tracks the status of the dispute.

It will be appreciated that the foregoing was a detailed description of certain the preferred embodiments and as such is subject to modification without departing from the principles of the invention. For example, although the initial lead collection and maintenance of the lead database is described as being operated by a third party, it is equally possible that the initial lead collection and maintenance of the lead database be conducted by the same entity that operates the remainder of the lead management system. In this example the third party database could be the same as the lead database shown in FIG. 1.

What is claimed is:

1. A computer program product for causing a lead management system to manage lead data, the program product comprising a computer useable medium having computer readable program code embodied in the medium that when executed by a processor causes the lead management system to:
communicate with a lead collection database to identify a new lead;
assign the new lead to a contractor drawn from a contractor database, said assignment based on criteria including the type of service and area where the service is required, and contractor resources and the contractor's performance in handling leads;
allow the contractor to update the status of the lead; and
flag the lead status to warn the contractor and/or a system manager if the status of the lead does not show the expected progress according to a predetermined timeline;
thereby providing means for ensuring that the contractor not only update the lead database, but that the contractor attends to the lead in a timely and proper manner.

2. The computer program product of claim 1, the program product comprising a computer useable medium having computer readable program code embodied in the medium that when executed by a processor further causes the lead management system to track the status of the lead in detail, said detail comprising date and details pertaining to:
when a contractor is assigned,
when the contractor executes a call back to the customer that requested service,
when a message is left for a customer,
when contact is made with the customer,
when a customer cancels or a contractor rejects a job,
when a quote is given,
when the quote is accepted, and
when the service has been performed;
thereby allowing accurate performance tracking of the various contractors and prompting of the contractors to ensure that leads are progressing as required; and
thereby further allowing for an assessment of specific and overall response times and hence of the responsiveness of the service request lead management system.

3. The computer program product of claim 1, further comprising a system manager interface to enable a system manager to keep track of the lead, the assignment and disposition of the lead and to report a lead management status to a retailer from time to time, or in real time.

4. The computer program product of claim 3, further comprising an accounting module integrated with the system to provide allocation of proceeds related to the generation of the lead and the servicing of the lead.

5. The computer program product of claim 3, further comprising a calendar module integrated with the system to display on daily, weekly and/or monthly calendars the appointments and tasks/obligations for each of one or more individual contractors or sub-contractors.

6. A method for managing lead information comprising:
receiving a lead from a potential customer;
collecting lead data from the potential customer relating to said lead;
recording said lead data in a lead data package in a prospect database;
generating a lead identification code for said lead;
associating said lead identification code with said lead data package in said prospect database;
providing access via interface for authorized individuals to retrieve information stored in said lead data in the prospect database;
maintaining a contractor database to store information relating to contractors;
accessing and identifying from the prospect database leads that are new and that relate to the type of services offered by contractors in the contractor database;
maintaining a lead database;
retrieving said lead data package from said prospect database for each new lead and storing said lead data package in a lead database;
marking the prospect database to indicate that the lead data package has been retrieved;
associating a lead status data field with the lead data package;
assigning a lead status value in the lead status data field to reflect a status of the lead;
assigning a contractor to be responsible for the lead;
assigning and tracking time limits for various lead status values;
assessing whether a time limit for a lead is overdue, and marking said lead status value as overdue if a time limit is exceeded;
periodically updating the prospect database with data corresponding to the lead status value;
upon authorized access by a contractor, displaying two or more of:
one or more system messages, if any;
a list of leads recently assigned to the contractor that the contractor has not yet contacted;
a list of overdue leads;
a list of leads that have a time limit for an action by the contractor expiring on that date; and
a list of leads for which a quote has been given but no further status has been updated;
upon authorized request by a contractor, displaying one or more of:
the lead identification code;
a date of lead creation;
a name and contact information for the potential customer;
a map of the immediate vicinity of the potential customer;
a type of service required;
other relevant details about the service request or potential customer;
a history of the lead;
a location of a nearest store; and
a location of a store where the potential customer shops;
normal messages;
general information, including documentation;
a search screen;
an area where the contractor can add, delete or otherwise manage sub-contractors; and
internet links to suppliers of raw materials;
upon authorized access by a system manager, displaying one or more of:
a list of unmatched leads;
a list of overdue leads;
a list of leads that have a time limit for an action expiring on that date;
upon authorized request by a system manager, displaying one or more of:
details relating to any lead;
details relating to any contractor;
timeliness of contractors;
financial performance summary information; and
financial performance detail information;
providing a user interface for contractor and system manager users which permits authorized users to update the lead status value and to add detail information to be stored in the lead data package;
upon authorized request via user interface by a system manager, permitting one or more of:
setting and adjusting the time limits for various steps in a lead life cycle;
generating and viewing reports based on information in the lead database and the contractor database, whether relating to sales generated by particular contractors or the timeliness of particular contractors;
sending messages to all contractors or specific contractors;
registering new contractors;
assigning unassigned leads to contractors; and
changing the status of a lead; and
if the lead status value indicates that a contractor rejected a lead, reassigning the lead to another contractor.

7. The method for managing lead information of claim 6 wherein providing interface access comprises providing access via a web interface using a standard internet connection.

8. The method for managing lead information of claim 6 wherein providing interface access for authorized individuals to retrieve information stored in the lead database comprises providing access through the use of a unique and secure login identification name and password.

9. The method for managing lead information of claim 6 wherein retrieving said lead data package from said prospect database for each new lead comprises running an automated script.

10. The method for managing lead information of claim 6 wherein assigning a contractor to be responsible said each lead comprises selecting a best contractor from a list of contractors by comparing the geographic location of the lead request with the geographic location of various contractors.

11. The method for managing lead information of claim 10 wherein assigning a contractor to be responsible said each lead further comprises selecting the best contractor from a list of contractors by comparing the type of service required with the type of service offered by various contractors.

12. The method for managing lead information of claim 6 further comprising determining the geographic location at which service of a lead is required and determining the location of a closest store from a selection of multiple stores; selecting a contractor from a list of contractors associated with that store and with that type of service.

13. The method for managing lead information of claim 6 wherein possible values for the lead status value comprise: contractor assigned; customer contacted; customer cancelled; contractor rejected; on hold; quote given; job sold; installation complete; unassigned; and overdue.

14. The method for managing lead information of claim 6 wherein maintaining a contractor database to store information relating to each contractor comprises maintaining contractor-specific information relating to: contact information; geographic location; type of service performed; number of personnel; amount of equipment operated; job history; sales target; and the total number of sales generated for a given period of time.

15. The method for managing lead information of claim 6 further comprising displaying, upon authorized request by the contractor, a graphical representation of how the contractors achieved sales and the contractors sales target compare.

16. The method for managing lead information of claim 6 further comprising a data field for tracking the purchases of raw materials by the contractor.

17. The method for managing lead information of claim 6 wherein providing a user interface for contractor and system manager users which permits authorized users to update the lead status value and to add detail information to be stored in the lead data package comprises prohibiting a contractor from updating the lead status value outside of certain values, namely to ensure that the contractor progresses the lead through the lead life cycle in a predefined systematic manner.
